(19) United States
(12) Patent Application Publication
(10) Pub. No.: US 2016/0319717 A1
(43) Pub. Date: Nov. 3, 2016

(54) ENGINE SYSTEM

(71) Applicant: Caterpillar Inc., Peoria, IL (US)

(72) Inventors: Yongli Qi, Peoria, IL (US); Xinyu Ge, Peoria, IL (US)

(73) Assignee: Caterpillar Inc., Peoria, IL (US)

(21) Appl. No.: 15/208,695

(22) Filed: Jul. 13, 2016

(51) Int. Cl. F01N 3/10; B01D 53/94

(52) U.S. Cl. CPC F01N 3/101; F01N 3/108; B01D 53/9418

(57) ABSTRACT

An engine system is provided. The engine system includes a first engine adapted to generate a first exhaust flow. The engine system includes a first aftertreatment unit associated with the first engine. The first aftertreatment unit receives at least a portion of the first exhaust flow therein. The engine system includes a second engine adapted to generate a second exhaust flow. The engine system also includes a second aftertreatment unit associated with the second engine. The second aftertreatment unit receives the second exhaust flow therein. The engine system further includes a distribution unit coupled to the first aftertreatment unit and the second aftertreatment unit. The distribution unit is adapted to selectively bypass a remaining portion of the first exhaust flow to the second aftertreatment unit. The remaining portion of the first exhaust flow is adapted to introduce an amount of unburned hydrocarbon (CxH2x) in to the second aftertreatment unit.

### TECHNICAL FIELD

The present disclosure relates to an engine system. More particularly, the present disclosure relates to an aftertreatment system for the engine system.

### BACKGROUND

Engines operating on natural gas fuel, generally utilize a lean combustion mixture for improving fuel efficiency and/or to limit exhaust emission thereof, within prescribed limits. Such engines may further employ either a Selective Catalytic Reduction (SCR) unit or a Lean Nitrogen Oxide (NO_{X}) Catalyst (LNC) unit, as part of an aftertreatment system thereof, to treat the NO_{X} present in an exhaust before being released in to the atmosphere.

The SCR unit requires an additional fluid, such as a Diesel Emission Fluid (DEF) to facilitate chemical reactions therein for conversion of the NO_{X} present in the exhaust. The engine may require an additional DEF storage and dosing components/systems thereby increasing system cost and/or complexity. The cost/complexity may further increase in situations when multiple engines may utilize the standalone SCR units.

The LNC unit requires unburned hydrocarbon for reduction of the NO_{X} present in the exhaust. The unburned hydrocarbon is a group of chemicals represent by C_{X}H_{Y}. A conversion efficiency of the LNC unit varies based on a type of unburned hydrocarbon and may generally follow an order such as C₂H₄>C₃H₆>C₃H₈>CH₄. The unburned hydrocarbon from a rich combustion mixture is dominated by C_{X}H_{2X}. The unburned hydrocarbon from the lean combustion mixture is dominated by methane (CH₄) especially with fuel having a methane number greater than 65.

The LNC unit requires a maximum amount of CH₄ within the exhaust received therein for an optimal rate of chemical reaction. However, in situation when the methane number of the natural gas fuel may be above 65, the amount of CH₄ present within the exhaust may be above a threshold for achieving the optimal rate of chemical reaction. This in turn may reduce the conversion efficiency of the LNC unit.

In order to reduce a negative impact of high methane number of the natural gas fuel, an additional fuel type and a fuel reforming system may have to be employed. The additional fuel type may require a separate storage and dispersing components/systems. The additional fuel type and/or the fuel reformer may increase packaging/system complexity, increase fuel consumption, and so on in turn resulting in increased system cost, operational cost, maintenance cost, and so on.

Additionally, the LNC unit requires to be operated at a minimum temperature for achieving a desired conversion efficiency thereof. A temperature of the exhaust generated by the engine when running with lean combustion mixtures may be low in a manner such that the temperature of the LNC unit may be below the minimum operating temperature thereof. As a result, the conversion efficiency of the LNC unit may be affected and may be below desired levels.

U.S. Published Application Number 2012/0042639 describes a power system having a first power source. The first power source includes an engine to combust a first air/fuel mixture and produces a first exhaust stream. A fuel of the first air/fuel mixture may be liquefied petroleum gas. The power system also has a first exhaust passageway connected to the first power source. The first exhaust passageway receives the first exhaust stream. The power system also has a second power source. The second power source includes an engine to combust a second fuel/air mixture and produces a second exhaust stream. The power system also has a second exhaust passageway connected to the second power source. The second exhaust passageway receives the second exhaust stream. The power system further has a first catalyst disposed within the first exhaust passageway to convert the first exhaust stream to ammonia.

### SUMMARY OF THE DISCLOSURE

In an aspect of the present disclosure, an engine system is provided. The engine system includes a first engine adapted to generate a first exhaust flow. The engine system includes a first aftertreatment unit associated with the first engine. The first aftertreatment unit is adapted to receive at least a portion of the first exhaust flow therein. The engine system includes a second engine adapted to generate a second exhaust flow. The engine system includes also a second aftertreatment unit associated with the second engine. The second aftertreatment unit is adapted to receive the second exhaust flow therein. The engine system further includes a distribution unit coupled to the first aftertreatment unit and the second aftertreatment unit. The distribution unit is adapted to selectively bypass a remaining portion of the first exhaust flow to the second aftertreatment unit. The remaining portion of the first exhaust flow is adapted to introduce an amount of unburned hydrocarbon (C_{X}H_{2X}) in to the second aftertreatment unit.

Other features and aspects of this disclosure will be apparent from the following description and the accompanying drawings.

### BRIEF DESCRIPTION OF THE DRAWINGS

FIG. 1 is a schematic representation of an aftertreatment system for an engine system, according to one embodiment of the present disclosure.

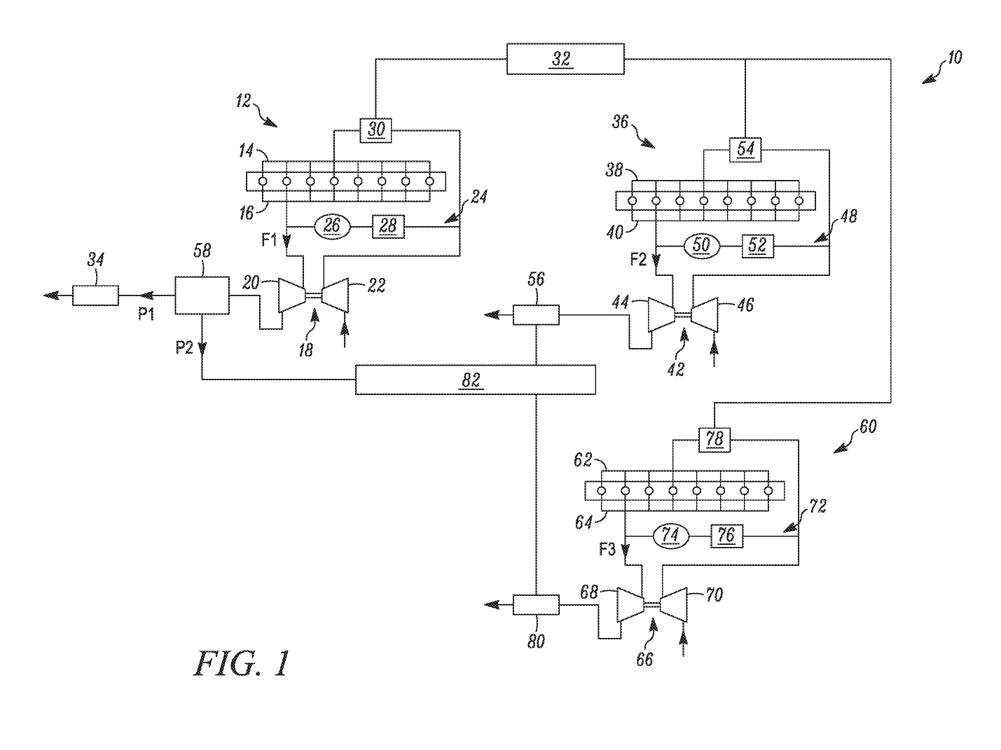

### DETAILED DESCRIPTION

Wherever possible, the same reference numbers will be used throughout the drawings to refer to the same or the like parts. Referring to FIG. 1, an exemplary engine system 10 is illustrated. The engine system 10 includes multiple engines interconnected with one another. Each of the multiple engines of the engine system 10 may be connected with one another in a parallel arrangement, a series arrangement, and/or may operate as a separate, standalone engine, and/or a combination thereof. The engine system 10 may be used for any application, such as power generation, marine, transportation, oil and gas, and so on.

The engine system 10 includes a first engine 12. The first engine 12 is an internal combustion engine powered by a natural gas fuel. The first engine 12 generates a first exhaust flow F1 due to combustion of the fuel therein. The first engine 12 may include an engine block (not shown). The engine block may include one or more cylinders (not shown) provided therein. The cylinders may be arranged in any configuration, such as inline, radial, “V”, and so on. The first engine 12 may also include a cylinder head (not shown) mounted on the engine block. The cylinder head may house one or more components and/or systems of the first engine 12, such as a first intake manifold 14, a first exhaust manifold 16, a valve train (not shown), sensors (not shown), and so on.

The first engine 12 includes a first turbocharger 18. The first turbocharger 18 includes a first turbine 20 and a first compressor 22 coupled to one another. The first turbine 20 is connected to the first exhaust manifold 16. Accordingly, the first turbine 20 receives the first exhaust flow F1 generated by the first engine 12. The first exhaust flow F1 rotates the first turbine 20 and in turn operates the first compressor 22. The first compressor 22 receives air from atmosphere. Based on operation of the first compressor 22 by the first turbine 20, the first compressor 22 compresses the received air therein. The compressed air is further supplied to the first intake manifold 14.

The first engine 12 includes a first Exhaust Gas Recirculation (EGR) circuit 24. The first EGR circuit 24 recirculates a portion of the first exhaust flow F1 in to the first intake manifold 14. The first EGR circuit 24 is provided downstream of the first exhaust manifold 16 and upstream of the first turbocharger 18. The first EGR circuit 24 includes a first EGR valve 26 and a first EGR cooler 28. The first EGR valve 26 bleeds the portion of the first exhaust flow F1, based on an open position thereof, from the first exhaust manifold 16. The portion of the first exhaust flow F1 is further received in the first EGR cooler 28. The first EGR cooler 28 reduces a temperature of the portion of the first exhaust flow F1 received therein before being supplied to the first intake manifold 14.

The first engine 12 includes a first mixer 30. The first mixer 30 is provided upstream of the first intake manifold 14. The first mixer 30 receives the fuel therein from a fuel tank 32 of the engine system 10. The first mixer 30 also receives the compressed air from the first turbocharger 18 and the portion of the first exhaust flow F1 from the first EGR circuit 24. The first mixer 30 creates a rich combustion mixture of the fuel, the compressed air, and the portion of the first exhaust flow F1. The rich combustion mixture is further supplied to the first intake manifold 14 and the cylinders of the first engine 12 for combustion. The first mixer 30 may be any air-fuel mixing device known in the art.

The first engine 12 also includes a first aftertreatment unit 34. The first aftertreatment unit 34 is coupled to the first exhaust manifold 16 via the first turbocharger 18. Accordingly, the first aftertreatment unit 34 receives at least a portion of the first exhaust flow F1 via the first turbocharger 18 and will be explained in more detail later. In the illustrated embodiment, the first aftertreatment unit 34 is a Three Way Catalyst (TWC) unit. The TWC unit reduces Nitrogen Oxides (NO_{X}) present in the first exhaust flow F1 in to Nitrogen (N₂) and Oxygen (O₂). The TWC unit also oxidizes Carbon Monoxide (CO) present in the first exhaust flow F1 in to Carbon Dioxide (CO₂). The TWC unit further oxidizes unburned hydrocarbon present in the first exhaust flow F1 in to CO₂ and Water (H₂O). In other embodiments, the first aftertreatment unit 34 may be any aftertreatment device known in the art adapted for rich combustion mixture engines or based on application requirements.

The engine system 10 also includes a second engine 36. The second engine 36 is similar in configuration to that of the first engine 12. The second engine 36 is an internal combustion engine powered by the natural gas fuel. The second engine 36 generates a second exhaust flow F2 due to combustion of the fuel therein. The second engine 36 may include an engine block (not shown). The engine block may include one or more cylinders (not shown) provided therein. The cylinders may be arranged in any configuration, such as inline, radial, “V”, and so on. The second engine 36 may also include a cylinder head (not shown) mounted on the engine block. The cylinder head may house one or more components and/or systems of the second engine 36, such as a second intake manifold 38, a second exhaust manifold 40, a valve train (not shown), sensors (not shown), and so on.

The second engine 36 includes a second turbocharger 42. The second turbocharger 42 includes a second turbine 44 and a second compressor 46 coupled to one another. The second turbine 44 is connected to the second exhaust manifold 40. Accordingly, the second turbine 44 receives the second exhaust flow F2 generated by the second engine 36. The second exhaust flow F2 rotates the second turbine 44 and in turn operates the second compressor 46. The second compressor 46 receives air from the atmosphere. Based on operation of the second compressor 46 by the second turbine 44, the second compressor 46 compresses the received air therein. The compressed air is further supplied to the second intake manifold 38.

The second engine 36 includes a second EGR circuit 48. The second EGR circuit 48 recirculates a portion of the second exhaust flow F2 in to the second intake manifold 38. The second EGR circuit 48 is provided downstream of the second exhaust manifold 40 and upstream of the second turbocharger 42. The second EGR circuit 48 includes a second EGR valve 50 and a second EGR cooler 52. The second EGR valve 50 bleeds the portion of the second exhaust flow F2, based on an open position thereof, from the second exhaust manifold 40. The portion of the second exhaust flow F2 is further received in the second EGR cooler 52. The second EGR cooler 52 reduces a temperature of the portion of the second exhaust flow F2 received therein before being supplied to the second intake manifold 38.

The second engine 36 includes a second mixer 54. The second mixer 54 is provided upstream of the second intake manifold 38. The second mixer 54 receives the fuel therein from the fuel tank 32 of the engine system 10. The second mixer 54 also receives the compressed air from the second turbocharger 42 and the portion of the second exhaust flow F2 from the second EGR circuit 48. The second mixer 54 creates a lean combustion mixture of the fuel, the compressed air, and the portion of the second exhaust flow F2. The lean combustion mixture is further supplied to the second intake manifold 38 and the cylinders of the second engine 36 for combustion. The second mixer 54 may be any air-fuel mixing device known in the art.

The second engine 36 also includes a second aftertreatment unit 56. The second aftertreatment unit 56 is coupled to the second exhaust manifold 40 via the second turbocharger 42. Accordingly, the second aftertreatment unit 56 receives the second exhaust flow F2 via the second turbocharger 42. In the illustrated embodiment, the second aftertreatment unit 56 is a Lean NO_{X} Catalyst (LNC) unit adapted for lean combustion mixture engines. Within the LNC unit, the unburned hydrocarbon and the NO_{X} react to form N₂, O₂ and H₂O.

The engine system 10 also includes a distribution unit 58. The distribution unit 58 is coupled to the first engine 12. More specifically, the distribution unit 58 is coupled between the first turbocharger 18 and the first aftertreatment unit 34. Accordingly, the distribution unit 58 receives the first exhaust flow F1 upstream of the first aftertreatment unit 34. The distribution unit 58 is also coupled upstream of the second aftertreatment unit 56. The distribution unit 58 may be any bypass device known in the art, such as a two way valve, a three way valve, a pressure regulated valve, a solenoid operated valve, a needle valve, a diaphragm valve, and so on.

The distribution unit 58 selectively distributes the first exhaust flow F1 in to a first portion P1 of the first exhaust flow F1 and a second portion P2 of the first exhaust flow F1. The distribution unit 58 supplies the first portion P1 of the first exhaust flow F1 to the first aftertreatment unit 34. The distribution unit 58 further supplies the second portion P2 of the first exhaust flow F1 to the second aftertreatment unit 56. Accordingly, the distribution unit 58 selectively supplies a portion of the first exhaust flow F1 to the first aftertreatment unit 34 and selectively bypasses a remaining portion of the first exhaust flow F1 to the second aftertreatment unit 56. The second portion P2/remaining portion of the first exhaust flow F1 is adapted to introduce an amount of unburned hydrocarbon (mostly C_{X}H_{2X}) in to the second aftertreatment unit 56 in addition to the C_{X}H_{2X} present in the second exhaust flow F2.

Additionally, the engine system 10 includes a third engine 60. The third engine 60 is similar in configuration to that of the first engine 12 and/or the second engine 36. The third engine 60 is an internal combustion engine powered by the natural gas fuel. The third engine 60 generates a third exhaust flow F3 due to combustion of the fuel therein. The third engine 60 may include various components, such as an engine block (not shown), a cylinder head (not shown), a third intake manifold 62, a third exhaust manifold 64, a valve train (not shown), sensors (not shown), and so on.

The third engine 60 includes a third turbocharger 66. The third turbocharger 66 includes a third turbine 68 and a third compressor 70 coupled to one another. The third turbine 68 is connected to the third exhaust manifold 64. Accordingly, the third turbine 68 receives the third exhaust flow F3 generated by the third engine 60. The third exhaust flow F3 rotates the third turbine 68 and in turn operates the third compressor 70. The third compressor 70 receives air from the atmosphere. Based on operation of the third compressor 70 by the third turbine 68, the third compressor 70 compresses the received air therein. The compressed air is further supplied to the third intake manifold 62.

The third engine 60 includes a third EGR circuit 72. The third EGR circuit 72 recirculates a portion of the third exhaust flow F3 in to the third intake manifold 62. The third EGR circuit 72 is provided downstream of the third exhaust manifold 64 and upstream of the third turbocharger 66. The third EGR circuit 72 includes a third EGR valve 74 and a third EGR cooler 76. The third EGR valve 74 bleeds the portion of the third exhaust flow F3, based on an open position thereof, from the third exhaust manifold 64. The portion of the third exhaust flow F3 is further received in the third EGR cooler 76. The third EGR cooler 76 reduces a temperature of the portion of the third exhaust flow F3 received therein before being supplied to the third intake manifold 62.

The third engine 60 includes a third mixer 78. The third mixer 78 is provided upstream of the third intake manifold 62. The third mixer 78 receives the fuel therein from the fuel tank 32 of the engine system 10. The third mixer 78 also receives the compressed air from the third turbocharger 66 and the portion of the third exhaust flow F3 from the third EGR circuit 72. The third mixer 78 creates a lean combustion mixture of the fuel, the compressed air, and the portion of the third exhaust flow F3. The lean combustion mixture is further supplied to the third intake manifold 62 and the cylinders of the third engine 60 for combustion. The third mixer 78 may be any air-fuel mixing device known in the art.

The third engine 60 also includes a third aftertreatment unit 80. The third aftertreatment unit 80 is coupled to the third exhaust manifold 64 via the third turbocharger 66. Accordingly, the third aftertreatment unit 80 receives the third exhaust flow F3 via the third turbocharger 66. In the illustrated embodiment, the third aftertreatment unit 80 is a Lean NO_{X} Catalyst (LNC) unit adapted for lean combustion mixture engines. Within the LNC unit, the unburned hydrocarbon and the NO_{X} react to form N₂, O₂ and H₂O.

Additionally or optionally, the engine system 10 includes a collector unit 82 coupled to the distribution unit 58, the second aftertreatment unit 56, and the third aftertreatment unit 80. The collector unit 82 receives the second portion P2 of the first exhaust flow F1 from the distribution unit 58. The collector unit 82 further distributes and supplies the second portion P2 of the first exhaust flow F1 to the second aftertreatment unit 56 and the third aftertreatment unit 80 based on application requirements. The collector unit 82 may be any storage and distribution device known in the art, such as a pressurized rail, an exhaust collector, and so on.

It should be noted that the collector unit 82 described herein is merely optional and may be employed in situations when the engine system 10 may include three or more engines. In situations when the engine system 10 may include only the first engine 12 and the second engine 36, the collector unit 82 may be omitted. Accordingly, the distribution unit 58 may be directly coupled to the second aftertreatment unit 56. Also, the engine system 10 may include one or more additional valves (not shown) provided between the distribution unit 58, the collector unit 82, the first aftertreatment unit 34, the second aftertreatment unit 56, the third aftertreatment unit 80, and so on based on application requirements without any limitation.

It should further be noted that the engine system 10 described herein may include any number of engines based on application requirements. Each of the engines of the engine system 10 may have a configuration similar or different from that of one another. Also, an arrangement of the first engine 12, the second engine 36, the third engine 60, and so on described herein is merely exemplary and may vary based on application requirements. The first engine 12, the second engine 36, the third engine 60, and so on may include additional components not described herein and/or may omit components described herein based on application requirements.

### INDUSTRIAL APPLICABILITY

The present disclosure relates to the engine system 10 having the first aftertreatment unit 34 associated with the first engine 12 and the second aftertreatment unit 56 associated with the second engine 36. The first engine 12 is operated on the rich combustion mixture. Accordingly, the first aftertreatment unit 34 is the TWC unit adapted for the rich combustion mixture engines. The second engine 36 is operated on the lean combustion mixture. Accordingly, the second aftertreatment unit 56 is the LNC unit adapted for the lean combustion mixture engines.

The engine system 10 also includes the distribution unit 58 to bypass the second portion P2 of the first exhaust flow F1 from the first engine 12 to the second aftertreatment unit 56. The distribution unit 58 supplies the first portion P1 of the first exhaust flow F1 to the first aftertreatment unit 34. In situations when the engine system 10 may include the third engine 60 or more engines, the collector unit 82 may be coupled between the distribution unit 58, the second aftertreatment unit 56, the third aftertreatment unit 80, and/or more aftertreatment units.

The collector unit 82 receives the second portion P2 of the first exhaust flow F1 from the distribution unit 58 and further supplies the second portion P2 of the first exhaust flow F1 to the second aftertreatment unit 56, the third aftertreatment unit 80, and/or more aftertreatment units based on application requirements. The second portion P2 of the first exhaust flow F1 is adapted to introduce the amount of unburned hydrocarbon (mostly C_{X}H_{2X}) in to the second aftertreatment unit 56, the third aftertreatment unit 80, and/or more aftertreatment units in addition to the C_{X}H_{2X} present in the second exhaust flow F2, the third exhaust flow F3, and so on respectively.

The introduction of the amount of unburned hydrocarbon (mostly C_{X}H_{2X}) in to the second aftertreatment unit 56, the third aftertreatment unit 80, and so on provides to increase the C_{X}H_{2X} content within the second aftertreatment unit 56, the third aftertreatment unit 80, and so on while operating the second engine 36, the third engine 60, and so on respectively on the lean combustion mixtures and/or operating on the natural gas fuel having higher methane number, such as 65 and above.

Also, as the first engine 12 operates on the rich combustion mixture, a temperature of the first exhaust flow F1 is higher than a temperature of the second exhaust flow F2, a temperature of the third exhaust flow F3, and so on. The introduction of the second portion P2 of the first exhaust flow F1 in to the second aftertreatment unit 56, the third aftertreatment unit 80, and so on increases a surface temperature of the second aftertreatment unit 56, the third aftertreatment unit 80, and so on respectively. The increase in the surface temperature in turn results in improved conversion rate, improved conversion efficiency, improved operational efficiency, and so on thereof.

The engine system 10 provides increasing the conversion rate, the conversion efficiency, the operational efficiency, and so on of the LNC units without employing additional fuel system, additional fuel reforming system, partial burning approach, and/or direct fueling within the LNC unit. This in turn may reduce system cost, packaging/system complexity, fuel consumption, operational cost, service/maintenance cost, and so on.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of the disclosure. Such embodiments should be understood to fall within the scope of the present disclosure as determined based upon the claims and any equivalents thereof.

What is claimed is:

1. An engine system comprising:
a first engine adapted to generate a first exhaust flow;
a first aftertreatment unit associated with the first engine, the first aftertreatment unit adapted to receive at least a portion of the first exhaust flow therein;
a second engine adapted to generate a second exhaust flow;
a second aftertreatment unit associated with the second engine, the second aftertreatment unit adapted to receive the second exhaust flow therein; and
a distribution unit coupled to the first aftertreatment unit and the second aftertreatment unit, the distribution unit adapted to selectively bypass a remaining portion of the first exhaust flow to the second aftertreatment unit, the remaining portion of the first exhaust flow adapted to introduce an amount of unburned hydrocarbon (C_{X}H_{2X}) in to the second aftertreatment unit.

2. The engine system of claim 1 further including a collector unit coupled between the distribution unit and the second aftertreatment unit.

3. The engine system of claim 1, wherein the first aftertreatment unit is a Three Way Catalyst (TWC) unit.

4. The engine system of claim 1, wherein the second aftertreatment unit is a Lean Nitrogen Oxide (NOx) Catalyst (LNC) unit.

5. The engine system of claim 1, wherein the first engine is adapted to operate on a rich combustion mixture.

6. The engine system of claim 1, wherein the second engine is adapted to operate on a lean combustion mixture.

7. The engine system of claim 1, wherein the first engine and the second engine operate on a natural gas fuel.
